(19) United States
(12) Patent Application Publication
(10) Pub. No.: US 2023/0231345 A1
(43) Pub. Date: Jul. 20, 2023

(54) POWER ADAPTER WITH SENSING CONTROL FUNCTION FOR LAMP LOAD

(71) Applicant: CHEN SHENG YANG, KAOHSIUNG (TW)

(72) Inventor: CHEN SHENG YANG, KAOHSIUNG (TW)

(21) Appl. No.: 17/577,683

(22) Filed: Jan. 18, 2022

(51) Int. Cl. H01R 13/66; H05B 45/3725

(52) U.S. Cl. CPC H01R 13/6683; H05B 45/3725; H01R 13/465

(57) ABSTRACT

A power adapter with a sensing control function for a lamp load comprises a plug case, a pin set, and a circuit board. The plug case has an exterior surface having an operation area. The pin set is mounted on the plug case. The circuit module is mounted in the plug case, is electrically connected to the pin set, and has a sensor board comprising a sensing conductor and a controller electrically connected to the sensing conductor. A position of the sensing conductor corresponds to a position of the operation area of the exterior surface of the plug case.

### BACKGROUND OF THE INVENTION

### 1. Field of the Invention

The present application relates generally to a power adapter, and more particularly to a power adapter with a sensing control function for a lamp load.

### 2. Description of Related Art

LED (light emitting diode) string light is a common device for decoration. In order to turn on and switch the lighting modes of the LED string light, with reference to FIG. 8, conventional devices such as a power adapter 60 and a control box 61 are applied to the LED string light. The control box 61 is detachably connected to the power adapter 60. Output of the control box 61 is electrically connected to the LED string light.

For example, the power adapter 60 may be inserted into a power socket on a wall, and convert an input power, such as a DC (Direct Current) power or an AC (Alternating Current) power, from the power socket to a suitable DC power to supply power to the control box 61 and the LED string light. The control box 61 has a physical button 610. When the physical button 610 is pressed by a user, the control box 61 can turn on/off the LED string light or switch lighting modes of the LED string light. It is to be understood that any one of the power adapter 60 and the control box 61 should be indispensable. Otherwise, neither the power adapter 60 nor the control box 61 can control the LED string light alone.

However, the power adapter 60 and the control box 61 are two separate devices and thus are individually manufactured. The material and production cost for their cases and printed circuit boards (PCBs) are hardly reduced. Besides, the control box 61 has a poor waterproof capability. For example, the case of the control box 61 should have a hole, such that the physical button 610 can be mounted in the hole. When the user accidentally spills a glass of water over on the control box 61, the water will infiltrate the control box 61 via the hole and damage the circuit board in the control box 61. In addition, the physical button 610 may include a metal dome that will rust easily to be damaged when in contact with water and oxygen. Hence, the service life of the physical button 610 is not that long.

### SUMMARY OF THE INVENTION

An objective of the present invention is to provide a power adapter with a sensing control function for a lamp load to overcome the defects of the conventional power adapter and the control box.

The power adapter with a sensing control function for a lamp load of the present invention comprises a plug case, a pin set, and a circuit board. The plug case has an exterior surface having an operation area. The pin set is mounted on the plug case. The circuit module is mounted in the plug case, is electrically connected to the pin set, and has a sensor board comprising a sensing conductor and a controller electrically connected to the sensing conductor. A position of the sensing conductor corresponds to a position of the operation area of the exterior surface of the plug case.

The power adapter of the present invention has the single plug case, and the sensor board is mounted in the plug case. In other words, the sensor board is not separated from the plug case. Therefore, the configuration of the plug case and the circuit module is much simplifier than that of the conventional power adapter and the control box. The material and production cost for the power adapter of the present invention will be less than those of the conventional power adapter and the control box.

Besides, the plug case of the present invention does not have an opening for mounting a physical button, so as to have a better waterproof capability than the conventional control box.

In addition, the sensor board of the present invention can sense the user’s operation while the user’s finger approaches the operation area of the plug case. The present invention does not adopt the physical button as the conventional control box. Hence, the present invention may have much longer service life than the conventional control box.

In conclusion, the defects of the conventional power adapter and the control box are overcome.

### BRIEF DESCRIPTION OF THE DRAWINGS

FIG. 1 is a side view of an embodiment of the power adapter of the present invention;

FIG. 2 is a top view of the embodiment of the power adapter of the present invention;

FIG. 3 is a top view of another embodiment of the power adapter of the present invention;

FIG. 4 is a block diagram of an embodiment of the circuit module of the power adapter of the present invention;

FIG. 5 is a partial cross-sectional view of an embodiment of the power adapter of the present invention;

FIG. 6 is a partial cross-sectional view of another embodiment of the power adapter of the present invention;

FIG. 7 is a schematic view showing a user’s finger is put on the operation area of the plug case of the power adapter of the present invention; and

FIG. 8 is a schematic view of a conventional power adapter and a control box for an LED string light.

### DETAILED DESCRIPTION OF PREFERRED EMBODIMENT(S)

The present invention is a power adapter with a sensing control function for a lamp load. In other words, the power adapter of the present invention is applied to the lamp load, such as an LED (light emitting diode) string light, an LED strip, an LED rope light, a lamp device, and so on. When receiving an input power, such as a DC (Direct Current) power or an AC (Alternating Current) power, the power adapter of the present invention will convert the input power to a suitable DC power and provide driving signals to the lamp load. As a result, the lamp load will be turned on according to the driving signals. The sensing control function is to switch lighting modes of the lamp load. For example, in general, the lighting modes may include a flashing mode, a brightness-gradual-changing mode, and a color-changing mode.

The power adapter of the present invention comprises a plug case, a pin set, and a circuit module.

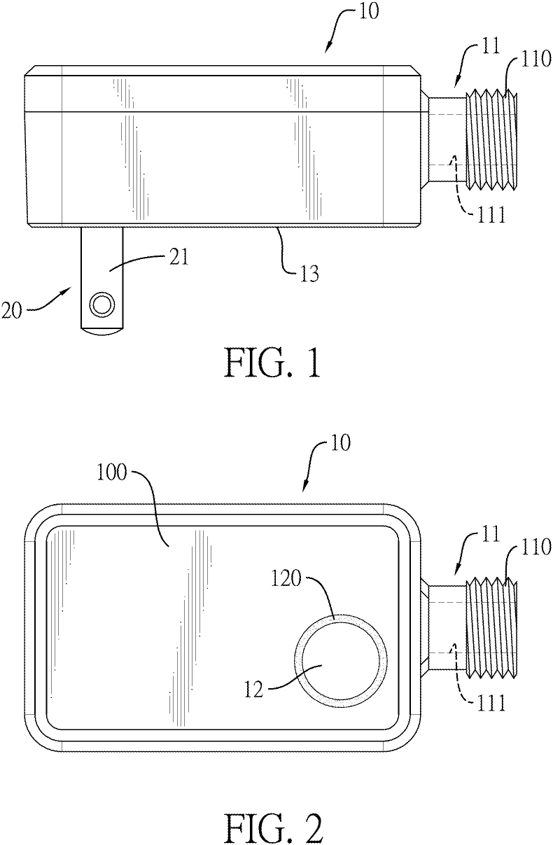

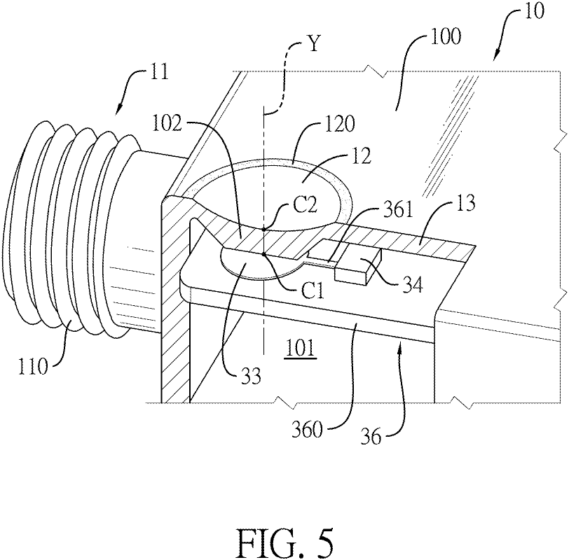

With reference to FIG. 1 and FIG. 2, the plug case 10 has an exterior surface 100. The plug case 10 is an electrical insulator, such as a plastic case. Besides, with reference to FIG. 5, the plug case 10 may have a mounting space 101 inside. As shown in FIG. 1 and FIG. 2, the plug case 10 has a connector 11. The connector 11 has a thread portion 110 and an opening 111. The opening 111 communicates with the mounting space 101 of the plug case 10. The exterior surface 100 of the plug case 10 has an operation area 12. In other words, the operation area 12 may be a part of the exterior surface 100 of the plug case 10. A user may put a finger on or above the operation area 12 to implement the sensing control function, which will be described as follows.

Besides, the present invention may comprise an indicator 120 formed on or around the operation area 12. For example, the indicator 120 may be a printed pattern or a sticker. The indicator 120 is used to indicate the position of the operation area 12. Seeing the indicator 120, the user may know the position of the operation area 12 and put the finger on or above it.

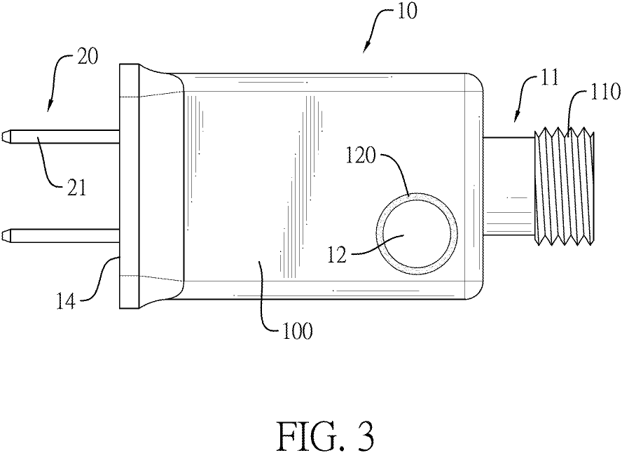

The pin set 20 is mounted on the plug case 10. For example, the pin set 20 may include multiple pins 21 to be inserted into a power socket on a wall. With reference to FIG. 1, the pin set 20 is mounted on a side wall 13 of the plug case 10, wherein the side wall 13 is adjacent to the connector 11. In another embodiment, as shown in FIG. 3, the pin set 20 may be mounted on an end wall 14 of the plug case 10, wherein the end wall 14 is opposite to the connector 11.

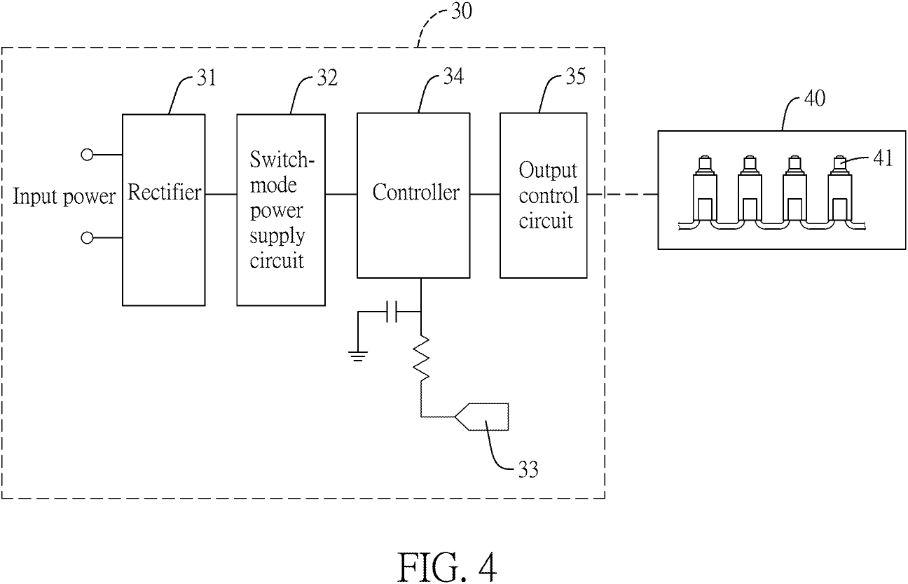

FIG. 4 depicts a circuit block diagram of the circuit module 30. Please note that the working principle of the circuit module 30 is conventional. In brief, the circuit module 30 may comprise a rectifier 31, a switch-mode power supply circuit 32, a sensing conductor 33, a controller 34, and an output control circuit 35 electrically connected in series. Input of the rectifier 31 is electrically connected to the pin set 20. Output of the output control circuit 35 is electrically connected to the lamp load 40. The lamp load 40 shown in FIG. 4 includes multiple LEDs 41 connected in series. Wires connected between the circuit module 30 and the lamp load 40 may be mounted through the opening 111 of the connector 11. When the pin set 20 is inserted into the power socket on the wall, the rectifier 31 and the switch-mode power supply circuit 32 may convert an input power from the power socket to a suitable DC power. The controller 34 is electrically connected to the sensing conductor 33 and performs the sensing control function. The output control circuit 35 is controlled by the controller 34 to output driving signals to the lamp load 40 to turn on the lamp load 40.

The physical structure of the circuit module 30 may comprise circuit board(s) and electrical components, such as resistors, capacitors, inductors, integrated-circuit chips (IC chips), and so on, mounted on the circuit board(s). The circuit module 30 is mounted in the mounting space 101 of the plug case 10. As mentioned above, the circuit module 30 is electrically connected to the pin set 20 and the lamp load 40. In an embodiment of the present invention, with reference to FIG. 5, the circuit module 30 may have a sensor board 36. The sensor board 36 comprises physical components of the sensing conductor 33 and the controller 34. The sensing conductor 33 and the controller 34 may be mounted on a printed circuit board (PCB) 360. The controller 34 may be electrically connected to the sensing conductor 33 through a wire 361.

For example, the controller 34 may be an IC chip. For example, the sensing conductor 33 may be a metal foil shaped as a filled circle, rectangle, triangle, or any other shapes. The metal foil may be a gold foil, a silver foil, a copper foil, an iron foil, an aluminum foil, and so on.

In the present invention, with reference to FIG. 5, the position of the sensing conductor 33 corresponds to the position of the operation area 12 of the exterior surface 100 of the plug case 10. Preferably, a center C1 of the sensing conductor 33 is aligned with a center C2 of the operation area 12 along a straight phantom line Y that is perpendicular to the side wall 13 of the plug case 10.

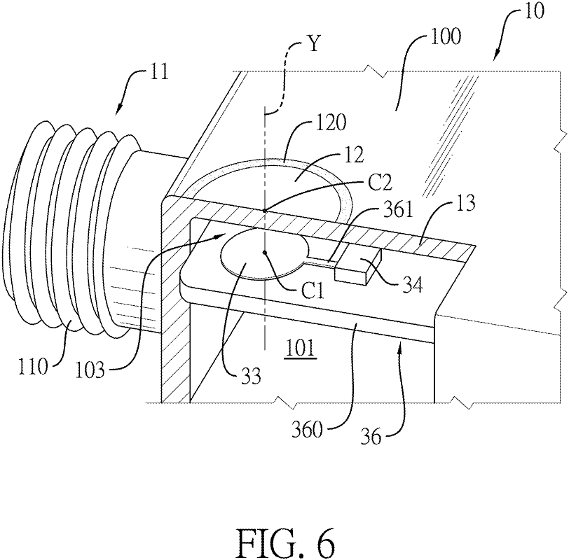

Regarding the operation area 12 of the plug case 10, in an embodiment as shown in FIG. 5, the operation area 12 may be a concave portion in the exterior surface 100 of the plug case 10. In another embodiment as shown in FIG. 6, the operation area 12 may be a flat plane in the exterior surface 100 of the plug case 10.

The sensing conductor 33 may contact an inner surface of the plug case 10. Or, there would be a gap between the sensing conductor 33 and the inner surface of the plug case 10. With reference to the embodiment shown in FIG. 5, the inner surface of the plug case 10 has a protrusion 102. The position of the protrusion 102 is between the operation area 12 and the sensing conductor 33. A bottom surface of the protrusion 102 contacts the surface of the sensing conductor 33.With reference to the embodiment shown in FIG. 6, the sensing conductor 33 is separate from the inner surface of the plug case 10, such that the gap 103 is formed between the sensing conductor 33 and the inner surface of the plug case 10.

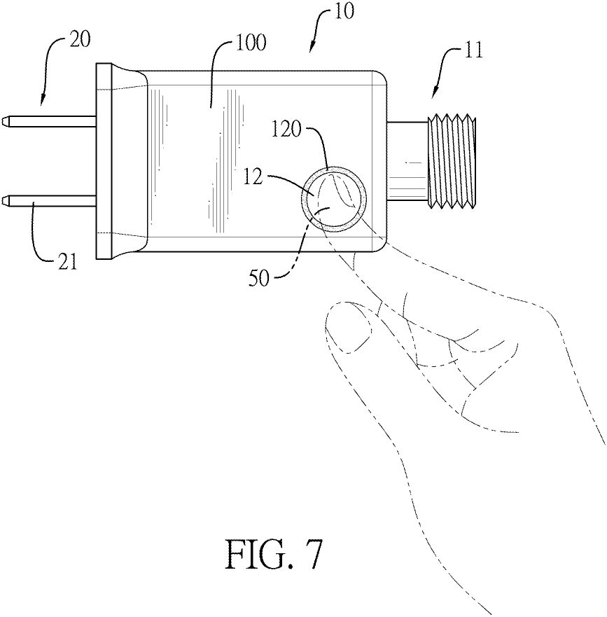

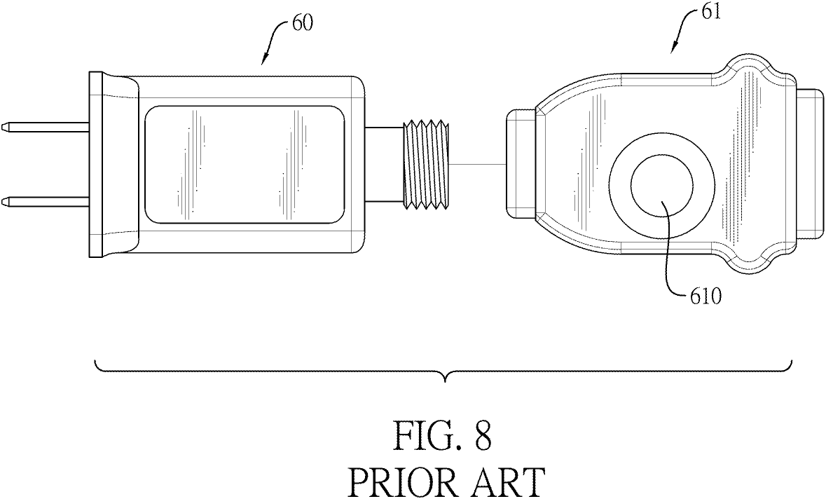

The working principle of the sensor board 36 is briefly introduced as follows. It is to be understood that the controller 34 may compute a resonant frequency according to a capacitance sensed from the sensing conductor 33. When the user does not put the finger on or above the operation area 12 of the plug case 10 yet, the controller 34 may determine that the resonant frequency is not varied. With reference to FIG. 7 and further to FIGS. 5 and 6, when the user’s finger 50 approaches the operation area 12 of the plug case 10, the side wall 13 of the plug case 10 is between the user’s finger 50 and the sensing conductor 33. As a result, the capacitance sensed from the sensing conductor 33 will be affected by the user’s finger 50 because the finger 50 is a conductor with electric charges. Then, the controller 34 may determine that the resonant frequency is varied due to the varied capacitance, so as to output the driving signal to the lamp load 40 via the output control circuit 35 to switch the lighting modes of the lamp load 40.

In the present invention, because the position of the sensing conductor 33 corresponds to the position of the operation area 12 of the plug case 10, the distance between the user’s finger 50 and the sensing conductor 33 is minimized, and the electric charges on the finger 50 may affect the sensing conductor 33 directly, such that the sensing effect of the sensing conductor 33 will be maximized and optimized.

The power adapter has advantages including:

1. The power adapter of the present invention has the single plug case 10 and the sensor board 36 for implementing the sensing control function. The sensor board 36 is included in the plug case 10 and not separated from it. In other words, the configuration of the plug case 10 and the circuit module 30 is much simplifier than that of the conventional power adapter 60 and the control box 61. Hence, the material and production cost for the power adapter of the present invention will be less than those of the conventional power adapter 60 and the control box 61.

2. The conventional power adapter 60 and the control box 61 are separate devices, such that the staff have to manually assemble them to each other. In comparison, the circuit module 30 of the present invention is already included in the plug case 10. The present invention does not have more than two cases to be manually assembled. The above-mentioned conventional assembly issue should be resolved in the present invention.

3. The power adapter of the present invention has the single plug case 10, so as to look more elegant than the conventional power adapter 60 and the control box 61.

4. The power adapter of the present invention has a better waterproof capability than the conventional control box 61 because the plug case 10 of the present invention does not have an opening for a physical button.

5. The sensor board 36 of the present invention can sense the user’s operation while the user’s finger approaches the operation area 12 of the plug case 10, even when the user’s finger does not contact the operation area 12 yet. The present invention does not adopt the physical button 610 as the conventional control box 61. Hence, the present invention may have much longer service life than the conventional control box 61.

6. The plug case 10 is an electrical insulator. Hence, when the user operates the power adapter of the present invention, even when the user’s finger contacts the operation area 12 of the plug case 10, the hazard of electric shock should be avoided.

What is claimed is:

1. A power adapter with a sensing control function for a lamp load, the power adapter comprising:
a plug case having an exterior surface having an operation area;
a pin set mounted on the plug case; and
a circuit module mounted in the plug case, electrically connected to the pin set, and having a sensor board comprising:
a sensing conductor; and
a controller electrically connected to the sensing conductor;
wherein a position of the sensing conductor corresponds to a position of the operation area of the exterior surface of the plug case.

2. The power adapter as claimed in claim 1, wherein the power adapter comprises an indicator formed on or around the operation area.

3. The power adapter as claimed in claim 1, wherein the pin set is mounted on a side wall of the plug case.

4. The power adapter as claimed in claim 1, wherein the pin set is mounted on an end wall of the plug case.

5. The power adapter as claimed in claim 1, wherein the sensing conductor is a metal foil.

6. The power adapter as claimed in claim 1, wherein a center of the sensing conductor is aligned with a center of the operation area.

7. The power adapter as claimed in claim 1, wherein the operation area is a concave portion in the exterior surface of the plug case.

8. The power adapter as claimed in claim 1, wherein the operation area is a flat plane in the exterior surface of the plug case.

9. The power adapter as claimed in claim 1, wherein the sensing conductor contacts an inner surface of the plug case.

10. The power adapter as claimed in claim 9, wherein the inner surface of the plug case has a protrusion having a bottom surface that contacts the sensing conductor.

11. The power adapter as claimed in claim 1, wherein the sensing conductor is separate from an inner surface of the plug case.

12. The power adapter as claimed in claim 1, wherein the plug case has a connector having a thread portion; the pin set is mounted on a side wall of the plug case; and the side wall is adjacent to the connector.

13. The power adapter as claimed in claim 1, wherein the plug case has a connector having a thread portion; the pin set is mounted on an end wall of the plug case; and the end wall is opposite to the connector.
